(19) United States
(12) Patent Application Publication
(10) Pub. No.: US 2022/0192269 A1
(43) Pub. Date: Jun. 23, 2022

(54) INDUCTION VAPORIZER

(71) Applicant: iVision Tech, Inc., Middletown, DE (US)

(72) Inventor: Ali Kohbodi, Irvine, CA (US)

(73) Assignee: iVision Tech, Inc., Middletown, DE (US)

(21) Appl. No.: 17/672,559

(22) Filed: Feb. 15, 2022

Related U.S. Application Data
(63) Continuation-in-part of application No. 17/124,908, filed on Dec. 17, 2020.

(51) Int. Cl. A24F 40/465; A24F 40/42; A24F 40/57; A24F 40/51; H05B 6/10; H05B 6/06; A24F 40/10

(52) U.S. Cl. CPC A24F 40/465; A24F 40/42; A24F 40/57; H05B 2206/02; H05B 6/108; H05B 6/06; A24F 40/10; A24F 40/51

(57) ABSTRACT

An induction vaporizer has an electromagnetic field generator configured according to a heating protocol. The metal heating element is configured to receive inductive heating from the electromagnetic field generator. The metal heating element is within a threshold distance of an electromagnetic field. A main ceramic member installed in contact with the metal heating element. The main ceramic member receives heat from the metal heating element. A temperature sensor is mounted to the main ceramic member. The metal heating element includes titanium, and is formed as a tube. The metal heating element at least partially encapsulates the main ceramic member. The main ceramic member has a main ceramic member floor with a main ceramic member floor. The main ceramic member floor has a thermal sensor indent. The temperature sensor is mounted in the thermal sensor indent of the main ceramic member floor.

This application claims priority from and is a continuation in part of U.S. non-provisional utility application Ser. No. 17/124,908 filed Dec. 17, 2020 entitled Portable Electronic Vaporizing Device by same inventor Ali Kohbodi, the disclosure of which is incorporated herein by reference.

### FIELD OF THE INVENTION

The present invention is in the field of electronic vaporizers.

### DISCUSSION OF RELATED ART

A variety of different electronic vaporizers have been described in the prior art for smoking articles. For example, U.S. Pat. No. 10,058,129 to Monsees describes a cartridge-based vaporizer using a heater that includes a first plate, a second plate, a wick, and a resistive heating element in contact with the first plate and the second plate. As another example, U.S. Patent Publication No. 10,517,334 to Volodarsky describes a vaporizer having an atomizer that uses a thermally conductive element. Volodarsky also describes an embodiment using thermal radiation, in which light is used to heat the substance, and also described an embodiment using convective technology, in which hot air is passed over a substance.

While vaporizers with heating elements are known in the art, there is still a need for improved devices that deliver heat in a precise and quick manner. These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### SUMMARY OF THE INVENTION

An induction vaporizer has an electromagnetic field generator configured according to a heating protocol. The metal heating element is configured to receive inductive heating from the electromagnetic field generator. The metal heating element is within a threshold distance of an electromagnetic field. A main ceramic member installed in contact with the metal heating element. The main ceramic member receives heat from the metal heating element. A temperature sensor is mounted to the main ceramic member. The metal heating element includes titanium, and is formed as a tube. The metal heating element at least partially encapsulates the main ceramic member. The main ceramic member has a main ceramic member floor with a main ceramic member floor. The main ceramic member floor has a thermal sensor indent. The temperature sensor is mounted in the thermal sensor indent of the main ceramic member floor.

The main ceramic member has a main ceramic member sidewall. The main ceramic member sidewall forms a main ceramic member lower indent. The main ceramic member lower indent is an indented portion of the main ceramic member sidewall. A main ceramic member lower sidewall extends downwardly from the main ceramic member sidewall. The metal heating element has a heating element inward protrusion. The heating element inward protrusion engages the main ceramic member lower indent. The lower ceramic member has a lower ceramic member sidewall. The lower ceramic member sidewall fits around an outside of the main ceramic member lower sidewall. The lower ceramic member sidewall and the main ceramic member lower indent sandwich and retain the heating element inward protrusion. The heating element inward protrusion is formed at a heating element lower bend.

The upper ceramic member fits over the main ceramic member. The upper ceramic member has airflow openings on an upper ceramic member floor. The upper ceramic member has upper tabs that engage upper tabs slots formed on the main ceramic member. Heating flanges are formed on the metal heating element, wherein the heating flanges extend outwardly. A filter is configured to direct a vaporized material to an outlet. A housing is configured to removably couple to the filter. The housing has a control interface that receives a user input. A control module processes at least the user input or the sensor input. The control module controls an execution of the heating protocol in response the at least of the user input and the sensor input. The induction assembly is separated and positioned substantially laterally to the filter.

The control interface further comprises a display, wherein the display is configured to transmit visual information associated with a temperature of the inductive element. The user input can be an electrical input or a physical input. An electromechanical mechanism can transduce the physical input into an electrical signal. The induction assembly has a cover that at least partially encloses the inductive element between the induction element and the cover in a closed configuration. An indicator optionally emits light, sounds, and tactile feedback. The user input can be a modification to the heating protocol. The control module is preferably operatively coupled to a wireless communication module, such as a wireless communication module that uses a communications protocol like a radio transmission, an infrared transmission, a microwave transmission, or a light wave transmission. The control module is operatively coupled to at least one sensor and the at least one sensor can be a temperature sensor, a capacitive touch sensor, a microphone, or a pressure sensor.

The lower ceramic member has a lower ceramic member sidewall that fits to the main ceramic member. The lower ceramic member has a lower ceramic member floor that includes a first polarity passage and a second polarity indent. The lower ceramic member floor receives electrical contacts on a lower surface of the lower ceramic member floor at the first polarity passage and the second polarity indent. The lower ceramic member floor encloses the temperature sensor. The electrical contacts include a first polarity contact installed to the first polarity passage, and a second polarity contact installed to the second polarity indent. The main ceramic member lower sidewall preferably engages with the lower ceramic member sidewall so as to form a thermal gap between the main ceramic member lower sidewall and the lower ceramic member sidewall. The main ceramic member lower sidewall protrusion is preferably formed on the main ceramic member lower sidewall. A main ceramic member lower sidewall protrusion can segment a thermal gap to form a first thermal gap above a second thermal gap.

The inventive subject matter provides a device comprising a filter configured to direct a vaporized material to an outlet, a housing configured to removably couple to the filter, an induction assembly. The housing can comprise a control interface, wherein the control interface receives a user input. The housing further comprises a control module, wherein the control module processes at least one of the user input and a sensor input.

The present invention contemplates that the control module can control an execution of a heating protocol in response at least the user input and the sensor input. The induction assembly further comprises an induction element configured to produce an electromagnetic field according to a heating protocol and an inductive element within a threshold distance of the electromagnetic field that is configured to at least partially convert electromagnetic radiation into heat. Various objects, features, aspects and advantages of the inventive subject matter will become more apparent from the following detailed description of preferred embodiments, along with the accompanying drawing figures in which like numerals represent like components.

In contrast to the prior art, the present invention describes system in which induction technology is used to heat an inductive element. By using induction technology to vaporize material, the present invention provides solutions to the shortcomings of non-inductive heating technologies. Advantages of inductive technologies include, but are not limited to, precise temperature control, easily exchangeable inductive containers for multiple consecutive uses, and speed of heating. As such, the present invention improves the speed and accuracy of heating over conventional vaporizers, which is especially important when volatilizing materials using heat. Applying the appropriate amount of heat based on the type of material with the accuracy of induction heating can improve user safety by reducing the formation of unwanted byproducts, such as smoke and associated carcinogens.

### BRIEF DESCRIPTION OF THE DRAWINGS

FIG. 1A depicts a cross-sectional view of an embodiment of a vaporizing device.

FIG. 1B depicts an anterior view of the vaporizing device of FIG. 1A.

FIG. 2A depicts an exploded view of the vaporizer device of FIG. 1A.

FIG. 2B depicts a cross-sectional view of the vaporizing device of FIG. 1A.

FIG. 3 is a perspective view of the present invention.

FIG. 4 is a top view of the present invention.

FIG. 5 is a side view of the present invention.

FIG. 6 is a side view of the present invention which could be the front, left, right or back side view as all are congruent.

FIG. 7 is a perspective side cross-section view of the present invention.

FIG. 8 is a top cutaway view of the present invention.

FIG. 9 is a side cross-section view of the present invention.

FIG. 10 is a side cross-section airflow diagram of the present invention.

The following call out list of elements can be a useful guide in referencing the elements of the drawings.
10 Induction Chamber Assembly
20 Upper Ceramic Member
21 First Upper Tab
22 Second Upper Tab
23 Third Upper Tab
24 Fourth Upper Tab
25 Upper Sidewall
26 Upper Depression
27 Upper Ceramic Member Floor
28 Air Flow Opening
29 Tab Offset
30 Main Ceramic Member
31 First Upper Tab Slot
32 Second Upper Tab Slot
33 Third Upper Tab Slot
34 Fourth Upper Tab Slot
35 Main Ceramic Member Sidewall
36 Main Ceramic Member Upper Protrusion
37 Main Ceramic Member Lower Indent
28 Main Ceramic Member Floor
39 Heating Chamber
40 Metal Heating Element
41 First Heating Flange
42 Second Heating Flange
43 Third Heating Flange
44 Fourth Heating Flange
45 Heating Element Lower Bend
46 Heating Element Inward Protrusion
47 Heating Element Sidewall
48 Heating Element Sidewall Inside Surface
49 Heating Element Sidewall Upper Edge
50 Lower Ceramic Member
51 First Polarity Passage
52 Second Polarity Indent
53 First Polarity Passage Shoulder
54 Lower Ceramic Member Floor
55 Lower Ceramic Member Sidewall
56 First Thermal Gap
57 Second Thermal Gap
58 Lower Ceramic Member First Abutment
59 Lower Ceramic Member Second Abutment
60 Thermal Sensor
61 Thermal Sensor Indent
62 Main Ceramic Member Floor Lower Surface
63 First electrical Prong Contact
64 Second electrical Prong Contact
65 High Temp Adhesive
66 Spring Piston
67 First electrical Polarity Contact
68 Second electrical Polarity Contact
69 Electrical Connection
70 Main Ceramic Member Lower Sidewall
71 Main Ceramic Member Lower Sidewall Protrusion
80 Carburetor Cap
81 Intake Airflow
82 Carburetor Cap Airflow
83 Heating Chamber Airflow
84 Over Side Of Chamber Airflow
85 Under Chamber Airflow
86 Horizontal Exhaust Airflow
87 Water Trap Chimney Airflow
88 Through Water Airflow
89 Exhaust Airflow
100 Vaporizing Device
102 Induction Element
104 Vapor Path
106 Control Module
108 Resistor
110 Power Conduit
112 Battery Pack
114 Indicator
116 Capacitor
118 Input Module
120 Control Interface
124 Button
126 Filter
202 Engagement Mechanism
204 Heating Assembly
206 Housing
208 Lid
210 Lid Assembly
212 Lid Assembly Holder
214 Inductive Cup
216 Induction assembly

### DETAILED DESCRIPTION OF THE PREFERRED EMBODIMENT

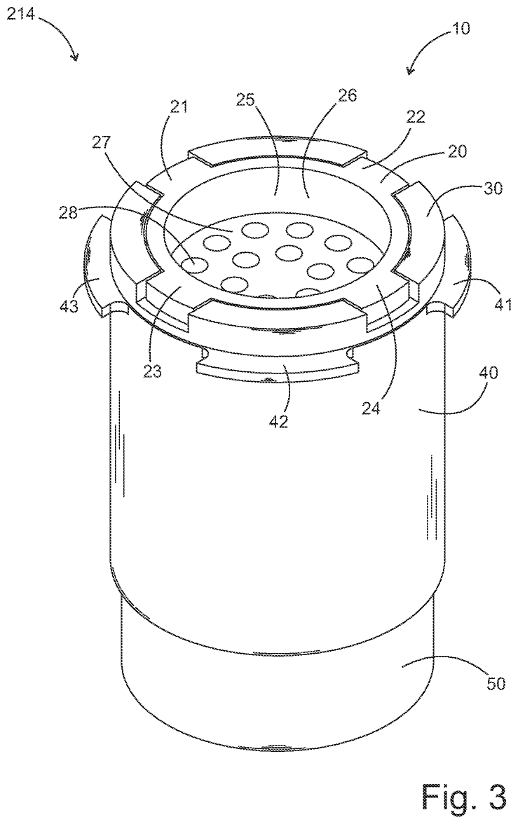

An induction chamber assembly 10 can provide a means for heating herbs in an electrically heated vaporizing appliance. A key part of the induction chamber assembly 10 is the inductive cup 214. As seen in FIG. 3, the inductive cup 214 can be formed as an induction chamber assembly 10 having an upper ceramic member 20 fitting over a main ceramic member 30, which fits inside a metal heating element 40, with a lower ceramic member 50 fitting to an underside of the main ceramic member 30 and the metal heating element 40. The metal heating element 40 receives inductive heating from the induction element 216 so that the metal heating element 40 heats up. The metal heating element 40 heats the main ceramic member 30. The metal heating element 40 is preferably titanium and transfers heat through the main ceramic member 30 which acts as a heat sink for receiving heat from the metal heating element 40. The lid assembly holder 212 has downwardly extending tabs that engage edges of flanges on the metal heating element. The induction chamber assembly 10 has an upper ceramic member 20 that is removable from a main ceramic member 30 to operate in different modes. In a first mode, the upper ceramic member 20 is removed from the main ceramic member 30, and in a second mode the upper ceramic member 20 is installed to the main ceramic member 30. The upper ceramic member 20 has multiple horizontally radially extending tabs at an upper portion of the upper ceramic member 20. The upper ceramic member 20 includes a first upper tab 21, a second upper tab 22, a third upper tab 23, and a fourth upper tab 24. The upper ceramic member 20 has an upper sidewall 25 formed as a tube that extends downwardly to an upper ceramic member floor 27 having air flow opening 28. An upper depression 26 is formed within the boundary of the upper sidewall 25 and the upper ceramic member floor 27.

The airflow openings 28 can be circular in cross-section to form cylindrical air passages. The radially extending tabs of the upper ceramic member 20 engage tab slots formed on the main ceramic member 30. The metal heating element 40 also has radially and horizontally extending flanges which include a first heating flange 41, second heating flange 42, third heating flange 43, and a fourth heating flange 44. The lower ceramic member 50, upper ceramic member 20, and the main ceramic member 30 can be made of the same ceramic material.

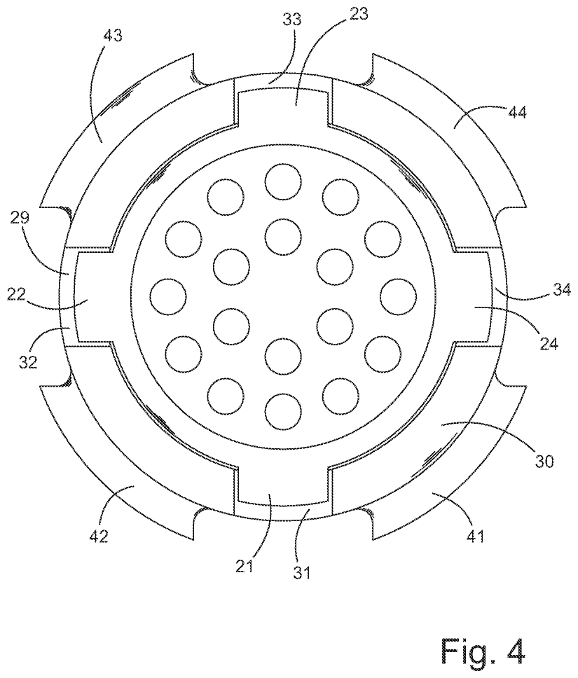

As seen in FIG. 4, a first upper tab 21 engages a first upper tab slot 31. A second upper tab 22 engages a second upper tab slot 32. A third upper tab 23 engages a third upper tab slot 33. A fourth upper tab 24 engages a fourth upper tab slot 34. The upper tab slots receive the upper tabs. The upper tab slots are formed on the main ceramic member 30 on an upper edge of the main ceramic member 30. The tabs are not as long as the slots such that there is a tab offset 29, less than a length of the tabs. The main ceramic member 30 has slots that are slightly larger than the tabs. The tab offset 29 occurs radially and also on the left and right side of each of the tabs so that there is a small gap. The metal heating flanges including the first heating flange 41, the second heating flange 42, the third heating flange 43, and the fourth heating flange 44 are between the tabs, between the tab slots, and lower than the tabs and the tab slots. The metal heating flanges have indents on their left and right sides to receive the downward protrusions of the lid assembly holder 21.

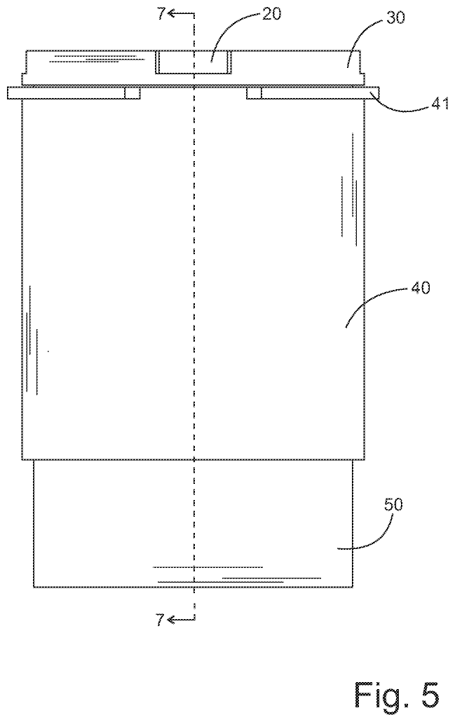

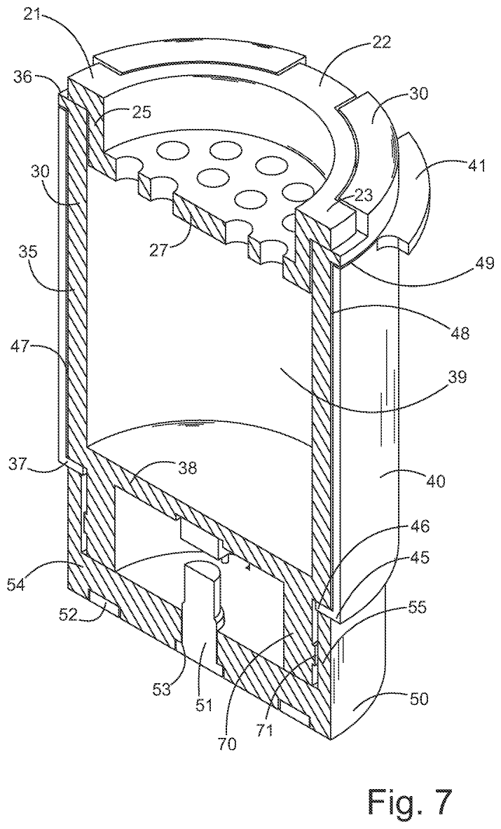

As seen in FIG. 5, the upper ceramic member 20 has an upper ceramic member upper surface that is flush to a main ceramic member upper surface of the main ceramic member 30. The metal heating element 40 has protrusions including a first heating flange 41 that protrudes as a rim. The lower ceramic member 50 has a smaller radius than the metal heating element 40 and has a smaller radius than the upper ceramic member 20. As seen in FIG. 5, the section view of FIG. 7 is taken from a bisected midline of FIG. 5.

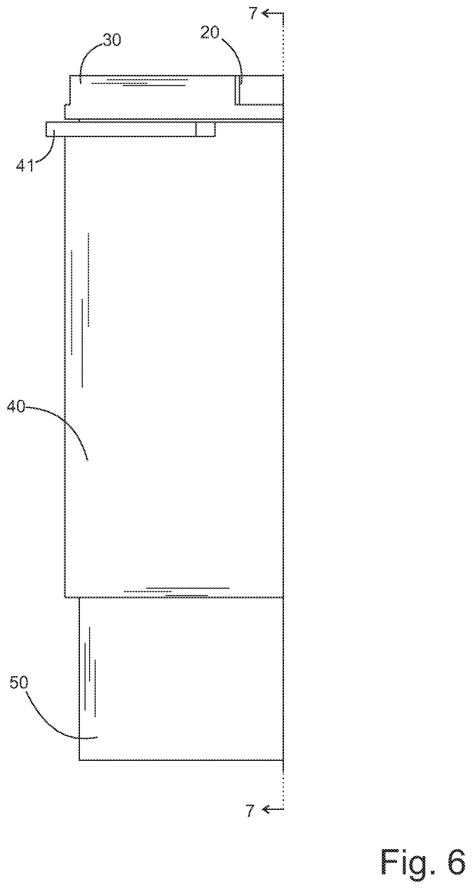

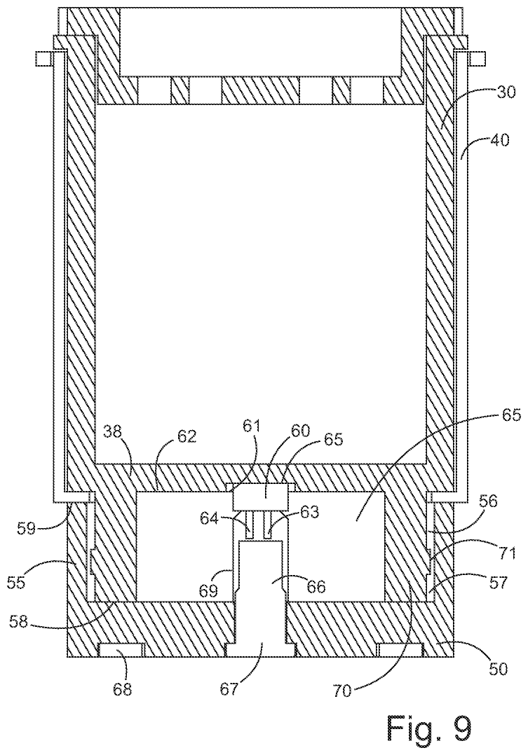

As seen in FIG. 6, a section view of FIG. 7 is taken from a bisected midline of FIG. 6. Further clarifying the section plane in FIG. 5 which is also the section plane of FIG. 9. The diagram in FIG. 6 shows that the lower ceramic member 50 receives the metal heating element 40 above it, with the main ceramic member 30 within the metal heating element 40. Then the upper ceramic member 20 is optionally installed to the main ceramic member 30.

As seen in FIG. 7, the main ceramic member 30 has a main ceramic member upper protrusion 36 which supports the upper ceramic member 20 at the first upper tab 21, the second upper tab 22, the third upper tab 23, and the fourth upper tab 24. The upper tabs extend outwardly from the upper sidewall 25 above the upper ceramic member floor 27 of the main ceramic member 30. The main ceramic member sidewall 35 is parallel to the upper sidewall 25 of the upper ceramic member 20. The upper sidewall 25 of the upper ceramic member 20 fits within the main ceramic member sidewall 35 of the main ceramic member 30. The upper tabs extend outwardly at a perpendicular angle to the upper sidewall 25. The main ceramic member upper protrusion 36 extends outwardly at a perpendicular angle to the main ceramic member sidewall 35.

The main ceramic member 30 has a main ceramic member lower indent 37 which receives the heating element inward protrusion 46 at a heating element lower bend 45. The heating element sidewall 47 bends inwardly at a heating element lower bend 45 to produce a heating element inward protrusion 46 around a circumferential periphery of the main ceramic member lower indent 37 so that the main ceramic member lower indent lower surface engages the heating element inward protrusion 46 at the heating element lower bend 45. The lower ceramic member 50 has a lower ceramic member sidewall 55 that cooperates with the main ceramic member lower indent 37 which the heating element inward protrusion 46 bears or engages upon.

The main ceramic member 30 has a main ceramic member floor 38 which supports the material being vaporized. The main ceramic member floor 38 forms a portion of the heating chamber 39. The metal heating element 40 is thus formed as a tube having a crimp on a lower edge at a heating element lower bend 45 and is formed with protruding flanges on an upper edge.

The heating element sidewall inside surface 48 engages the main ceramic member sidewall external surface of the main ceramic member sidewall 35. The heating element sidewall upper edge 49 is preferably flush with the main ceramic member upper protrusion 36.

The lower ceramic member 50 is preferably air gapped from the main ceramic member 30, and includes a first polarity passage 51 and a second polarity indent 52 which is also a passage that passes through the lower ceramic member floor 54 to an interior portion of the lower ceramic member 50. The first polarity passage 51 has a first polarity passage shoulder 53 which receives a shoulder of an electrical stud contact. The lower ceramic member floor 54 receives the electrical contacts for the temperature sensor as well as having an upper floor surface that support the main ceramic member 30 at a main ceramic member lower sidewall 70. The main ceramic member lower sidewall 70 has a main ceramic member lower sidewall protrusion 71 that is formed as an annular protrusion that fits to, nests with, aligns with, and preferably abuts an inside surface of the lower ceramic member sidewall 55. The main ceramic member lower sidewall 70 has a smaller diameter than the heating element sidewall 47 and the main ceramic member sidewall 35.

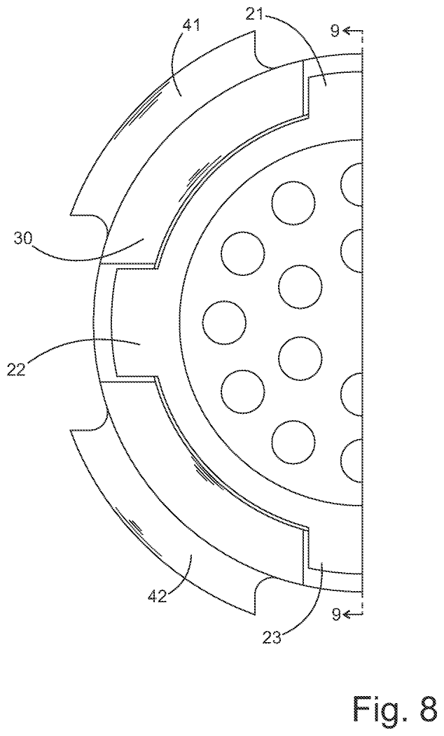

As seen in FIG. 8, the section line for FIG. 9 shows that the first upper tab 21 and the third upper tab 23 are at a midline of the apparatus. The second upper tab 22 has a rounded outside edge. The main ceramic member 30 has a thickness greater than the thickness of the upper ceramic member 20. The metal heating element 40 has a thickness less than a thickness of the main ceramic member 30. The first heating flange 41 and the second heating flange 42 have pointed tips at their corners to hook onto the downwardly protruding tabs of the lid assembly holder 212.

As seen in FIG. 9, the main ceramic member 30 has an air gapped interface with the lower ceramic member 50. The main ceramic member 30 and the lower ceramic member 57 sandwich the metal heating element 40 between them.

The main ceramic member lower sidewall 70 has a main ceramic member lower sidewall protrusion 71 that splits a circumferential lever to the oriented air gap between a first thermal gap 56 and a second thermal gap 57. The main ceramic member floor 38 heats up, and heat is conducted downwardly into the main ceramic member lower sidewall 70. Heat is then conducted to a lower ceramic member first abutment 58 where the lower ceramic member 50 abuts the main ceramic member lower sidewall 70 of the main ceramic member 30. The lower ceramic member second abutment 59 occurs where the lower ceramic member sidewall abuts the lower surface of the heating element inward protrusion 46.

The thermal sensor 60 can be formed as a thermistor, thermocouple or the like. The thermal sensor 60 has a flat upper surface that is lodged within a thermal sensor indent 61 at a main ceramic member floor lower surface 62. High temperature adhesive 65 adheres the thermal sensor to the thermal sensor indent 61 formed on the main ceramic member floor 38. The high temperature adhesive 65 preferably encapsulates a majority of the external surface area of the thermal sensor 60 forming a blob.

The lower ceramic member 50 has an air cavity that allows for loose wire or at least some slack in wire that extends outwardly from the thermal sensor 60. Preferably, pair of wires or posts extend outwardly from the thermal sensor 60 which can be formed as a semiconductor package. The wires or posts extending from the thermal sensor 60 include a first sensor lead 63 connecting to a first polarity contact 67 and a second sensor lead 64 connecting to a second polarity contact 68 to make an electrical connection pair 69. The lower ceramic member 50 receives a first polarity contact 67 in a center portion through its center opening, and a plurality of second electrical polarity contacts 68 such that the second electrical polarity contacts 68 are spaced apart at 120 degrees from each other. The electrical connection pair 69 is formed when the first and second sensor leads are soldered to the first and second polarity contacts. Optionally, the first polarity contact 67 can be formed of the spring piston that has a downward spring bias for making electrical connection with the induction assembly 216.

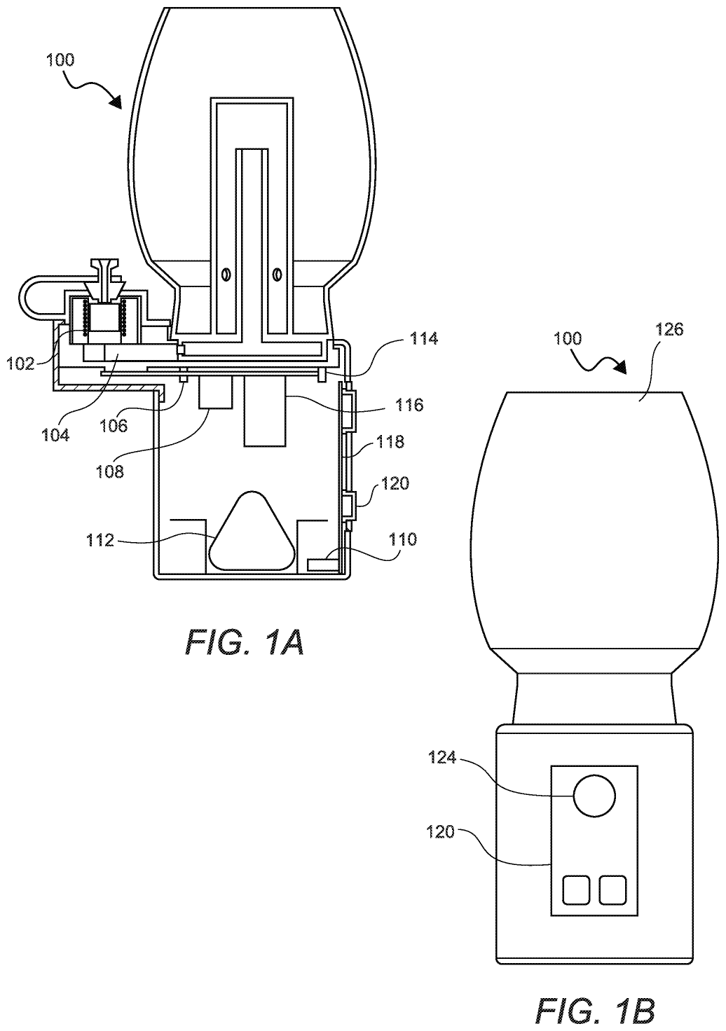

The induction chamber assembly 10 is removably installed to a vaporizing device 100. FIG. 1A depicts a cross-sectional view of a vaporizing device 100. Vaporizing device 100 is depicted as including, but is not limited to including, induction element 102, vapor path 104, control module 106, resistor 108, power conduit 110, battery pack 112, indicator 114, capacitor 116, input module 118, and control interface 120.

Induction element 102 is a type of electrical transformer that uses a fluctuating magnetic field to induce voltage across a coil. For example, induction element 102 is formed as a coil which is an electromagnetic field generator, which can be a copper induction coil. Induction element 102 is configured to send electromagnetic radiation to an inductive material to be converted to thermal energy. Inductive material can include metal components with high ferrous metal content, such as iron and magnetic grade stainless steels.

Vapor path 104 is an opening sized and dimensioned to allow the flow of gases and particulates suspended therein through from a first opening to a second opening. In preferred embodiments, vapor path 104 is coupled to a heating element at a first end and coupled to a filter pathway configured to filter the gases and particulates. For example, vapor path 104 can separate an inductive heating element that volatilizes a substance into a heated vapor and a water filter pathway that percolates the heated vapor through water to reduce the temperature and filter out undesirable elements, such as ash.

Control module 106 may include any one or more control components configured to control the flow of signals to one or more coupled electronic components. In one embodiment, control module 106 is a printed circuit board configured to control the operation of any one or more electronic components. For example, control module 106 can include integrated circuits configured to transmit one or more electrical signals produced via user inputs to cause power to be delivered to an inductive heating element. In another example, control module 106 may include integrated circuits configures to transmit one or more electrical signals to a timing module.

In some embodiments, control module 106 may include multiple sub-units. For example, control module 106 may include a collection of operatively coupled modules, such as timing modules, heating modules, user interface modules, and/or the like. Control module 106 may be configured to send one or more electrical signals to any one or more receivers configured to process incoming signals.

Control module 106 may also be coupled to one or more memory storage devices configured to store one or more program instructions. For example, memory storage devices can include FLASH memory that stores program instructions, such as heating protocols for induction element 102, lighting protocols, timing protocols, and any other type of storable program instructions. It is further contemplated that control module 106 can change one or more stored program instruction in response to an external input. For example, control module 106 can be configured to manage the installation and execution of a software update from a manufacturer. In another example, control module 106 can be configured to alter existing program instructions in response to user input, such as heating preferences, lighting effects, and/or the like.

In some embodiments, control module 106 may be operatively coupled to other devices using a wireless connection. For example, control module 106 may send wireless signals, including, but not limited to, radio transmissions, infrared transmissions, microwave transmissions, and light wave transmissions.

In one embodiment, control module 106 is operatively coupled to a heating element. For example, control module 106 may be operatively coupled to an induction heating element. In other embodiments, control module 106 is operatively coupled to one or more modules configured to control the operation of vaporizer 100. For example, control module 106 may be configured to receive one or more user inputs causing control module 106 to send an electrical signal to a lighting module, thereby controlling the timing, colors, and brightness of one or more lights.

In some embodiments, control module 106 may include one or more processor. For example, control module 106 may include one or more microprocessors, microcontrollers, and embedded processors to control how one or more functions of vaporizer 100 are executed. In a related example, control module 106 may use one or more processors to dynamically adjust how a material is heated based on one or more variables, such as ambient temperature, amount of material, type of material, and/or status of power sources.

Resistor 108 is a device having a designated resistance for the passage of electric signals enabling the transmission of electric signals from control module 106 to indicator 114 and other electronic components. In some embodiments, vaporizer 100 does not include resistor 108.

The power conduit 110 can be formed as a means of connecting vaporizer 100 to an external power source. For example, power conduit 110 can be a USB-C female receptacle connector capable of enabling the flow of electricity to one or more components of vaporizer 100. In some embodiments, power conduit 110 can additionally or alternatively include wireless means of connecting vaporizer 100 to an external power source. For example, power conduit 110 can include a receive coil in an inductive system for wirelessly transmitting power to vaporizer 100.

Power source 112 can include any source of electricity used to operate vaporizer 100. In preferred embodiments, power source 112 is a power storage medium. For example, power source 112 may be a set of batteries. As used herein, batteries may include, but are not limited to, disposable, replaceable and/or rechargeable batteries. For example, batteries may include any one or more of an alkaline, lead acid battery, or a lithium-ion battery. Power source 112 is electrically configured to deliver the voltage to power one or more components of vaporizer 100, such as indicator 114.

In another embodiment, power source 112 includes an electrical conduit physically coupled to a grounded outlet at a first end and to vaporizer 100 at a second end. For example, power source 112 can be a conventional plug that is physically coupled to an electrical outlet.

In yet another embodiment, power source 112 can include a portable power source (e.g., battery) and a substantially fixed power sources (e.g., conventional electrical outlets). For example, power source 112 can include a physical electrical conduit, such as a USB-C cable, and a rechargeable battery. In such embodiments, the present invention can be configured to draw power from any one or more power sources in combination or individually.

Indicator 114 can include any one or more means for alerting a user. In a preferred embodiment, indicator 114 includes one or more lights, such as light-emitting diodes (LED), that are configured to activate in response to one or more input signals. For example, indicator 114 can include an RGB LED light that is configured to emit the color red in response to induction element 102 reaching a temperature of 400-500° C. Indicator 114 can be configured to emit lights of various colors and brightness. In some embodiments, indicator 114 can be operatively coupled to one or more elements associated with control module 106. For example, indicator 114 can be an LED light coupled to a microcontroller, wherein the microcontroller can receive user inputs and send program instructions to change the color and brightness of the LED light according to the user inputs.

In one embodiment indicator 114 is electrically coupled to a heating element to display colors based on the temperature range reached. In another embodiment, indicator 114 is electrically coupled to the user control inputs to process one or more user inputs. For example, indicator 114 can be configured to display a rainbow effect when transitioning from the default display mode to another mode. As another example, indicator 114 can be configured to display white while in a default display mode. Indicator 114 can be configured to display a red heating icon providing indication that the vaporizing device 100 is in the process of heating. In another example, indicator 114 is configured to display green once the requisite heating temperature is reached. Indicator 114 is configured to display a logo and “Power ON” sign when the power button is pressed.

Capacitor 116 is a device that stores electrical energy and is composed of at least two electrical conductors separated by an insulator. In some embodiments, vaporizer 100 does not include capacitor 116. Input module 118 is a printed circuit board configured to receive input from the device controls such as the control interface 120.

Control interface 120 can be any means for translating user input into one or more signals managed by control module 106. In one embodiment, control interface 120 is a button pad configured to receive input controlling the behavior of the vaporizer, such as heating and timing characteristics, based on the user's selection of one or more operations parameters, including, but not limited to, a material to be vaporized, user-customized heating preferences, and/or the like.

Once control interface 120 receives input on the desired mode, control interface 120 is configured to cause control module 106 to cause induction element 102 to heat up in a manner prescribed by the desired mode. For example, control interface 120 can receive an input of dry herb as the material, which causes control module 106 to execute a heating protocol at a temperature range and timing that increases the efficiency of vaporization.

FIG. 1B depicts an anterior view of a vaporizing device 100. As depicted, vaporizing device 100 further includes input element 124 operatively coupled to control interface 120 and filter 126. Control interface 120 can include a display associated with the operation of vaporizer 100.

Control interface 120 can include any one or more elements that can individually and/or cooperatively control the operation of vaporizer 100. For example, control interface 120 can include a screen that displays one or more temperature options to a user via a software user interface. In another example, control interface 120 can include one or more haptic feedback mechanisms to allow a user to operate vaporizer 100 without a direct line of sight. In yet another example, control interface 120 can include a microphone to detect one or more user voice commands. In a final illustrative example, control interface 120 can include a speaker to communicate information to a user, such as an alert when an inductive element reaches a target temperature.

In some embodiments, control interface 120 may include one or more physical inputs, such as button 124. It is contemplated that button 124 can include any one or more means of translating a user input into a signal. For example, button 124 can translate a user input of five presses of button 124 to turn off vaporizer 100. In one embodiment, button 124 can be a transducer configured to change physical pressure on a button to an electrical signal using one or more electromechanical mechanisms, such as transducers. For example, button 124 can extend the duration of heating time of an induction heating element.

Transducers can include any means by which one form of energy can be converted to another. For example, transducers can include, but are not limited to, pressure transducers, inductive transducers, displacement transducers, oscillator transducers, photovoltaic transducers, piezoelectric transducers, electromagnetic transducers, and Hall Effect transducers. Transducers can also include active transducers or passive transducers.

In other embodiment, button 124 is activated using alternative and/or additional means. For example, button 124 can be activated via a user input into a capacitive touch sensor operatively coupled to button 124. It is further contemplated that button 124 can be operatively coupled to one or more computer implemented program instructions, such as software that can offer additional customizability and functionality associated with a user input.

In some embodiments, vaporizer 100 includes one or more computing components, including, but not limited to, a computer processor, a volatile memory storage, a non-volatile memory storage, and an input/output interface. For example, vaporizer 100 can include a propriety system on a chip (SoC) to execute one or more computer implemented program instructions in response to one or more inputs. Inputs can be received from any one or more sensors. In one example, sensors can include electromechanical mechanisms actuated via intentional user input, such as piezoelectric mechanisms. In another example, sensors can include mechanisms that do not require intentional user input, such as light sensors, temperature sensors, accelerometers, sound sensors, and/or the like.

Filter 126 can include any means by which vaporized material is delivered to an outlet. In the depicted embodiment, filter 126 is positioned proximate to the vapor path 104 to allow the flow of vapor through vapor path 104 to an opening of filter 126.

In preferred embodiments, filter 126 includes a lumen that is physically configured to at least partially filter vaporized material and gases through a liquid layer. For example, filter 126 can be a water filter that percolates vaporized material and gases through water via a filtering pathway.

In other embodiments, filter 126 comprises a lumen that is configured to increase the distance between a source of heated vapor to an outlet, such as a mouthpiece. For example, filter 126 can be a coiled tube that increases the physical distance that vaporized material travels to reach an outlet. In one embodiment, filter 126 includes a gasket configured to seal a connection between an opening of filter 126 and engagement mechanism 202, discussed in further detail below, of vaporizing device 100. For example, filter 126 can include a detachable gasket that uses a resilient material to secure filter 126 to engagement mechanism 202, thereby creating a sealed connection with housing 206 of vaporizer 100. Filter 126 can be secured to housing 206 using engagement mechanism 202 via any mechanism that can create a substantially sealed fit between filter 126 and housing 206. For example, filter 126 can secure onto housing 206 using any one or more of a screw fit, a snap fit, a pressure-based fit, and a magnet-based fit.

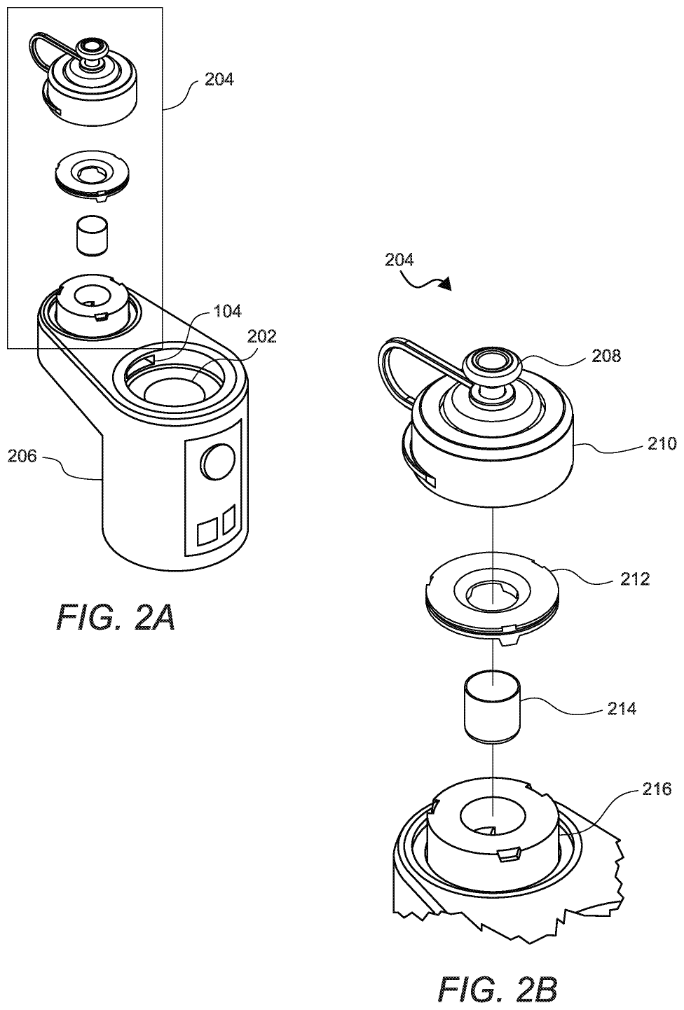

FIG. 2A depicts an exploded view of vaporizer device 100. Vaporizer device 100 further includes vapor path 104, engagement mechanism 202, heating assembly 204, and housing 206. In the depicted embodiment, induction assembly 204 includes lid 208, lid assembly 210, lid assembly holder 212, inductive cup 214, and induction assembly 216. Induction assembly 204 will be described in further detail in the description of FIG. 2B below. Engagement mechanism 202 can include any mechanism that can create a substantially sealed fit between filter 126 and housing 206. For example, engagement mechanism 202 can be sized and configured to allow any one or more of a screw fit, a snap fit, a pressure-based fit, and a magnet-based fit between filter 126 and housing 206. Housing 206 can be a housing that includes any one or more operatively coupled components associated with the operation of vaporizer 100. Housing 206 can be made from any one or more materials. Materials can include, but are not limited to, plastics, metals, woods, ceramics, glass, composite materials, and resilient materials (i.e., silicone and rubbers).

In some embodiments, housing 206 includes multiple physically coupled components. For example, housing 206 can include a substantially rigid acrylonitrile butadiene styrene housing with a removable silicone sleeve configured to add resilient characteristics to the device. Vapor pathway 104 is an opening sized and dimensioned to allow the flow of gases and particulates suspended therein through from a first opening to a second opening. In preferred embodiments, vapor pathway 104 is coupled to a heating element at a first end and coupled to a filter pathway configured to filter the gases and particulates. For example, vapor path 104 can separate an inductive heating element that volatilizes a substance into a heated vapor and a water filter pathway that percolates the heated vapor through water to reduce the temperature and filter out undesirable elements, such as ash.

FIG. 2B depicts a cross-sectional view of vaporizing device 100. As depicted, induction assembly 204 includes lid 208, lid seating 210, cover 212, inductive element 214, and induction assembly 216. Lid 208 can be any mechanism by which air inflow to vaporizer 100 is regulated. In the depicted embodiment, lid 208 is a removable physical barrier that can be switched from a substantially sealed to a substantially unsealed state, or vice versa, to control the inflow of air in and through housing 206.

In some embodiments, lid 208 can be an electromechanical mechanism configured to automatically close and open in response to a change in one or more variables. For example, lid 208 can be operatively coupled to an anemometer in housing 206, which can cause lid 208 to substantially cut off air intake by changing a physical configuration of lid 208. However, the present invention contemplates the use of any mechanism along the airflow path configured to substantially prevent airflow through housing 206. For example, housing 206 can include an actuator assembly configured to impede airflow in response to a trigger, such as a detected period of non-use, by physically sealing off vapor pathway 104.

Lid seating 210 can include any one or more mechanisms configured to removably couple with lid 208. In preferred embodiments, lid assembly holder 210 is at least partially made of an insulating material. For example, lid assembly holder 210 can be made of glass. In another example, lid assembly holder 210 can be made of ceramic. In yet another example, lid assembly holder 210 can be made of silicone.

Lid 208 and lid seating 210 can removably mate using any mechanism. For example, lid 208 and lid seating 210 can removable mate using any one or more of a screw mechanism, a snap fit mechanism, a pressure-based fit mechanism, and a magnetic attachment mechanism. Cover 212 is a unit configured to removably couple and substantially cover induction element 216 when cover 212 is coupled to induction element 216. Cover 212 and induction element 216 can removably couple in any manner known in the art, including through physical and/or magnetic means. In the depicted embodiment, cover 212 is further configured to removably couple with lid seating 210. The cover 212 can be made of any one or more materials. For example, cover 212 can be made of any one or more of a ceramic material, a metal, a plastic, a glass, a silicone-based material, and/or the like. In preferred embodiments, cover 212 is made of materials that are configured to withstand the maximum heat output of vaporizer 100 as determined by the configuration of inductive element 214 and induction element 216.

Inductive element 214 can include any inductive materials that are sized and shaped to transfer heat via inductive technologies to a material. In the depicted embodiment, inductive element 214 is a cup that is sized and dimensioned to be placed between induction element 216 and cover 212.

The present invention advantageously contemplates the use of substantially non-porous materials in inductive element 214. The use of non-porous materials advantageously reduces the adherence of the heated material to the increased surface area of substantially porous surfaces. For example, inductive element 214 can be made of an inductive alloy that defines a substantially smooth lumen having substantially non-porous inner walls. In another example, inductive element 214 can be made of a combination of inductive and non-inductive materials, such as a metal cup made of induction-grade stainless steel that is enameled using a powdered glass.

Inductive element can be composed of materials including, but not limited to, magnetic grade stainless steels and other metal components with high ferrous metal content. Inductive element 214 is configured to allow for precise temperature control, thereby allowing for an equal, consistent, temperature throughout the chamber. By enabling highly precise temperature control, vaporizer 100 can adapt heating protocols (e.g., timing and temperatures) to adapt to the material to be heated and at least partially vaporized. The use of inductive element 214 also reduces hot spots, which increases temperature consistency and reduces inaccurate temperature readings.

Induction element 216 includes any one or more elements configured to cause inductive element 214 to increase in temperature. For example, induction element 216 can include an induction coil configured to create an electromagnetic field in response to the flow of an alternative current through the induction coil.

Induction element 216 receives a flow of electricity to heat inductive element 214 in a manner determined by control interface 120 and control module 106 in response to one or more inputs and/or variables. For example, control interface 120 can receive and send user inputs that cause control module 106 to enable the flow of an alternating current to induction element 216 until a designated temperature is reached.

In some embodiments, control module 106 can receive inputs from one or more sensors, such as temperature sensors, in order to control the manner in which inductive element 214 is heated. For example, control module 106 can receive temperature readings in 1 millisecond increments to ensure that the temperature of inductive element 214 stays consistent. In a related example, control module 106 can cause one or more processors to execute a heating protocol that automatically heats inductive element 214 in accordance with a particular heating protocol for a particular material, such as a solventless concentrate of a plant material.

Induction element 216 can be configured to receive user-customized inputs. For example, induction element 216 can receive a user-created heating protocol that causes inductive element to be heated for an ordered series of temperatures, each with a specific heating duration.

In preferred embodiments, induction element 216 is capable of heating substances including but not limited to tobacco, cannabis, lavender, chamomile, and various plant materials. In preferred embodiments, induction element 216 is configured to heat up the selected substance within a predetermined period of time. For example, if one or more user inputs triggers the heating of plant materials, induction element 216 can be limited to an available temperature range of 240° F. to 430° F. (115° C. to 221° C.) and the session duration will range from 2 minutes to 5 minutes. In another example, if one or more user inputs triggers the heating of concentrated oil-based extracts, induction element 216 can be limited to an available temperature range of 450° F. to 710° F. (230° C. to 377° C.). Induction element 216 can also be limited to a session duration from a range of 20 seconds to 1 minute. In some examples, the session duration can be dependent on one or more session variable. Session variables can include but are not limited to, a type of material being heated, a desired user vaporizing experience, a type of power source, an availability of power, and a safety-related restriction In this way, the present invention advantageously allows for material specific adjustments to be made to the manner in which a particular material is heated.

In some embodiments, induction element 216 is removable from vaporizing device 100. In other embodiments, induction element 216 is electrically coupled with indicator 114 to communicate information regarding a heating cycle. For example, indicator 114 can display colors based on the temperature range reached in the heat chamber. In another example, indicator 114 can provide tactile feedback to a user in the form of vibration or other haptic feedback mechanisms. In yet another example, indicator 114 can provide auditory feedback by causing a voice prompt to communicate that inductive element 214 has reached the target temperature.

In the depicted embodiment, induction element 216 is advantageously positioned substantially laterally from filter 126. For example, induction element 216 can be positioned in a separate lateral portion of housing 206, such that inductive element 214 and induction element 216 are separately accessible. In such embodiments, it is contemplated that the physical separation of the inductive elements of vaporizer advantageously allows a user to access inductive element 214 directly by removing cover 212. For example, a user can remove a first inductive element, such as a small cup made of a ferrous material, with a second inductive element that is similarly sized and dimensioned. In this way, a user can quickly exchange inductive cups containing spent material with replacement inductive cups containing unspent material. Laterally separating inductive element 214 and induction element 216 from filter 126 also advantageously allows a user to access inductive element 214 without requiring removal of filter 126. In conventional stacked arrangements, heating elements can be positioned below a filter with a mouthpiece, which requires the removal of the filter to access the spent material in the heating elements.

In another embodiment, inductive element 214 is configured to run a cleaning protocol without having to removing the inductive cups from vaporizer 100. For example, induction element 216 can be configured to receive user input from control interface 120 that designates a high temperature mode. Control module 106 can execute a high temperature mode that will clear additional residue remaining in inductive element 214 to reduce the amount of remnant materials within an interior volume of the inductive cup. During the cleaning protocol, vaporizer 100 can include one or more notifications, such as a warning reminding the user not to use the device and a “cleaning” status notification.

Additionally, the present invention also increases the physical separation one or more electrical and inductive components from filter 126, which can increase safety in embodiments where filter 126 contains a liquid.

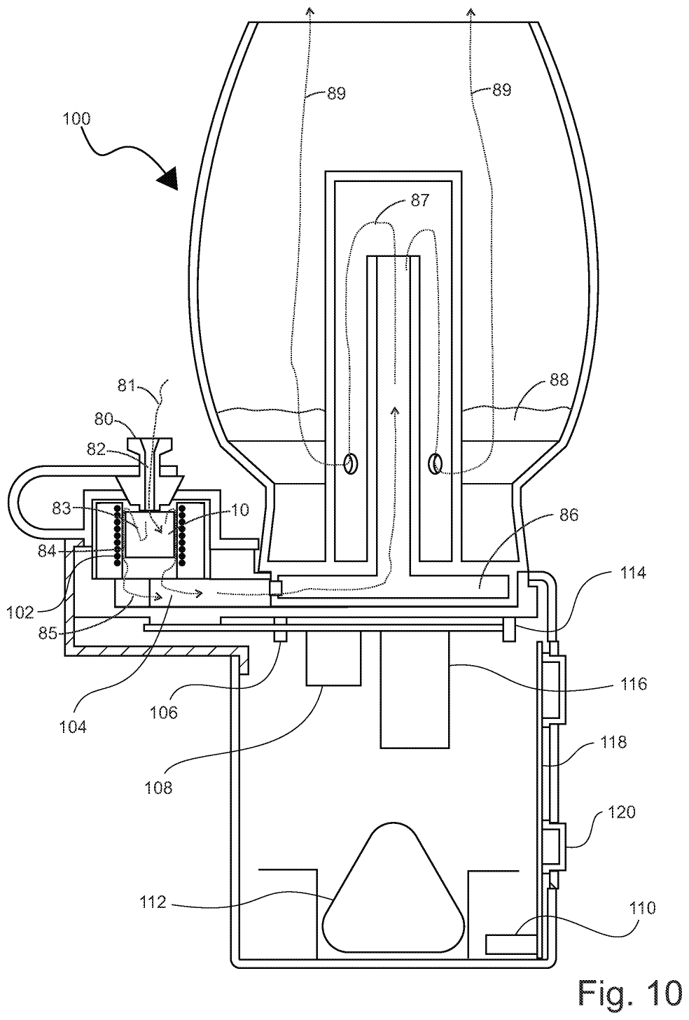

As seen in FIG. 10, air flows through the carburetor cap as an air intake and out of the chimney as an air outlet. The carburetor cap 80 has an intake opening that directs air and can direct air as a vortex stream into the heating chamber. The intake airflow 81 extends downwardly into the heating chamber. After the heating chamber has vaporized the plant material, the carburetor cap airflow 82 slows down at the heating chamber airflow 83. Over side of chamber airflow 84 begins at the upper outer edge of the chamber and flows over the edge until it is under the chamber. The constant airflow transfers heat away from the chamber and the inductive coils and acts as cooling. The under chamber airflow 85 cause the lower part of the chamber. The under chamber airflow 85 extends to the horizontal exhaust airflow 86. The horizontal exhaust airflow 86 passes to the water trap chimney airflow 87 then the through water airflow 88 as bubbles. Then, the airflow exhausts as exhaust airflow 89.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

The above discussion provides example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

Also, as used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

1. An induction vaporizer comprising:
an electromagnetic field generator configured according to a heating protocol; and
a metal heating element, wherein the metal heating element is configured to receive inductive heating from the electromagnetic field generator, wherein the metal heating element is within a threshold distance of an electromagnetic field;
a main ceramic member installed in contact with the metal heating element, wherein the main ceramic member receives heat from the metal heating element;
a temperature sensor mounted to the main ceramic member.

2. The induction vaporizer of claim 1, wherein the metal heating element includes titanium, and is formed as a tube, wherein the metal heating element at least partially encapsulates the main ceramic member, wherein the main ceramic member has a main ceramic member floor with a main ceramic member floor, wherein the main ceramic member floor has a thermal sensor indent, wherein the temperature sensor is mounted in the thermal sensor indent of the main ceramic member floor.

3. The induction vaporizer of claim 2, wherein the main ceramic member has a main ceramic member sidewall, wherein the main ceramic member sidewall forms a main ceramic member lower indent, wherein the main ceramic member lower indent is an indented portion of the main ceramic member sidewall, wherein a main ceramic member lower sidewall extends downwardly from the main ceramic member sidewall, wherein the metal heating element has a heating element inward protrusion, wherein the heating element inward protrusion engages the main ceramic member lower indent.

4. The induction vaporizer of claim 3, further including a lower ceramic member, wherein the lower ceramic member has a lower ceramic member sidewall, wherein the lower ceramic member sidewall fits around an outside of the main ceramic member lower sidewall, wherein the lower ceramic member sidewall and the main ceramic member lower indent sandwich and retain the heating element inward protrusion, wherein the heating element inward protrusion is formed at a heating element lower bend.

5. The induction vaporizer of claim 4, further including an upper ceramic member, wherein the upper ceramic member fits over the main ceramic member, wherein the upper ceramic member has airflow openings on an upper ceramic member floor.

6. The induction vaporizer of claim 5, wherein the upper ceramic member has a upper tabs that engage upper tabs slots formed on the main ceramic member.

7. The induction vaporizer of claim 6, further including heating flanges formed on the metal heating element, wherein the heating flanges extend outwardly.

8. The induction vaporizer of claim 4, further including:
a lower ceramic member, wherein the lower ceramic member has a lower ceramic member sidewall, wherein the lower ceramic member sidewall fits around an outside of the main ceramic member lower sidewall, wherein the lower ceramic member sidewall and the main ceramic member lower indent sandwich and retain the heating element inward protrusion, wherein the heating element inward protrusion is formed at a heating element lower bend; and
a filter configured to direct a vaporized material to an outlet;
a housing configured to removably couple to the filter, wherein the housing further comprises: a control interface, wherein the control interface receives a user input; a control module, wherein the control module processes at least one of the user input and a sensor input, and wherein the control module controls an execution of the heating protocol in response the at least of the user input and the sensor input, and wherein the induction assembly is separated and positioned substantially laterally to the filter.

9. The induction vaporizer of claim 8, wherein the control interface further comprises a display, wherein the display is configured to transmit visual information associated with a temperature of the inductive element, wherein the user input is at least one of an electrical input and a physical input, wherein an electromechanical mechanism transduces the physical input into an electrical signal, wherein the induction assembly further comprises a cover, wherein the cover at least partially encloses the inductive element between the induction element and the cover in a closed configuration, further comprising an indicator, wherein the indicator emits light, wherein the indicator emits sounds, wherein the indicator emits tactile feedback, wherein the user input is a modification to the heating protocol, wherein the control module is operatively coupled to a wireless communication module, wherein the wireless communication module uses a communications protocol selected from the group consisting of: a radio transmission, an infrared transmission, a microwave transmission, and a light wave transmission.

10. The induction vaporizer of claim 1, wherein the main ceramic member has a main ceramic member sidewall, wherein the main ceramic member sidewall forms a main ceramic member lower indent, wherein the main ceramic member lower indent is an indented portion of the main ceramic member sidewall, wherein a main ceramic member lower sidewall extends downwardly from the main ceramic member sidewall, wherein the metal heating element has a heating element inward protrusion, wherein the heating element inward protrusion engages the main ceramic member lower indent.

11. The induction vaporizer of claim 10, further including a lower ceramic member, wherein the lower ceramic member has a lower ceramic member sidewall, wherein the lower ceramic member sidewall fits around an outside of the main ceramic member lower sidewall, wherein the lower ceramic member sidewall and the main ceramic member lower indent sandwich and retain the heating element inward protrusion, wherein the heating element inward protrusion is formed at a heating element lower bend.

12. The induction vaporizer of claim 11, further including an upper ceramic member, wherein the upper ceramic member fits over the main ceramic member, wherein the upper ceramic member has airflow openings on an upper ceramic member floor.

13. The induction vaporizer of claim 12, wherein the upper ceramic member has a upper tabs that engage upper tabs slots formed on the main ceramic member.

14. The induction vaporizer of claim 13, further including heating flanges formed on the metal heating element, wherein the heating flanges extend outwardly.

15. The induction vaporizer of claim 11, further including:
a lower ceramic member, wherein the lower ceramic member has a lower ceramic member sidewall, wherein the lower ceramic member sidewall fits around an outside of the main ceramic member lower sidewall, wherein the lower ceramic member sidewall and the main ceramic member lower indent sandwich and retain the heating element inward protrusion, wherein the heating element inward protrusion is formed at a heating element lower bend; and
a filter configured to direct a vaporized material to an outlet;
a housing configured to removably couple to the filter, wherein the housing further comprises: a control interface, wherein the control interface receives a user input; a control module, wherein the control module processes at least one of the user input and a sensor input, and wherein the control module controls an execution of the heating protocol in response the at least of the user input and the sensor input, and wherein the induction assembly is separated and positioned substantially laterally to the filter.

16. The induction vaporizer of claim 15, wherein the control interface further comprises a display, wherein the display is configured to transmit visual information associated with a temperature of the inductive element, wherein the user input is at least one of an electrical input and a physical input, wherein an electromechanical mechanism transduces the physical input into an electrical signal, wherein the induction assembly further comprises a cover, wherein the cover at least partially encloses the inductive element between the induction element and the cover in a closed configuration, further comprising an indicator, wherein the indicator emits light, wherein the indicator emits sounds, wherein the indicator emits tactile feedback, wherein the user input is a modification to the heating protocol, wherein the control module is operatively coupled to a wireless communication module, wherein the wireless communication module uses a communications protocol selected from the group consisting of: a radio transmission, an infrared transmission, a microwave transmission, and a light wave transmission.

17. The device of claim 16, wherein the control module is operatively coupled to at least one sensor and wherein the at least one sensor is chosen from the group of: a temperature sensor, a capacitive touch sensor, a microphone, or a pressure sensor.

18. The device of claim 1, further including: a lower ceramic member, wherein the lower ceramic member has a lower ceramic member sidewall that fits to the main ceramic member, wherein the lower ceramic member has a lower ceramic member floor that includes a first polarity passage and a second polarity indent, wherein the lower ceramic member floor receives electrical contacts on a lower surface of the lower ceramic member floor at the first polarity passage and the second polarity indent, wherein the lower ceramic member floor encloses the temperature sensor, wherein the electrical contacts includes a first polarity contact installed to the first polarity passage, and a second polarity contact installed to the second polarity indent.

19. The device of claim 18, further including: main ceramic member lower sidewall engaging with the lower ceramic member sidewall so as to form a thermal gap between the main ceramic member lower sidewall and the lower ceramic member sidewall.

20. The device of claim 18, further including: a main ceramic member lower sidewall protrusion formed on the main ceramic member lower sidewall, wherein the main ceramic member lower sidewall protrusion segments the thermal gap to form a first thermal gap above a second thermal gap.
